(19) United States
(12) Patent Application Publication
(10) Pub. No.: US 2022/0192445 A1
(43) Pub. Date: Jun. 23, 2022

(54) Garage air-n-vac station

(71) Applicant: David Hamilton VanGorder, Rockford, MI (US)

(72) Inventor: David Hamilton VanGorder, Rockford, MI (US)

(21) Appl. No.: 17/545,460

(22) Filed: Dec. 8, 2021

Related U.S. Application Data
(60) Provisional application No. 63/205,403, filed on Dec. 8, 2020.

(51) Int. Cl. A47L 5/14; A47L 7/00; A47L 9/14; A47L 9/24; A47L 9/00; A47L 5/36; A47L 9/28

(52) U.S. Cl. CPC A47L 5/14; A47L 7/0085; A47L 9/1409; A47L 9/2857; A47L 9/0027; A47L 9/0036; A47L 5/36; A47L 9/248

(57) ABSTRACT

The Garage Air-N-Vac Station is an integrated wall-mounted vacuum, blower, and air compressor. The integrated system includes provisions for wall-mounting, tool and accessory storage, a wand hanger, and hose hangers for the combined vacuum/blower hose as well as the compressed air hose. The vacuum and blower sections of the machine are powered by a combination vacuum/blower motor, with the vacuum function utilizing the intake side of the vacuum/blower motor, and the blower function utilizing the discharge side of the vacuum/blower motor. A tankless compressor provides compressed air at full capacity. The machine is operated by a single 3-way control switch (On-Off-On) to activate either the vacuum/blower function or the compressor function. The elements that make this invention new and novel relate to its multi-function capabilities, combined with the integrated wall-mounting, tool, and hose storage system that has been optimized for ease of installation, convenience of use, organization, and appearance.

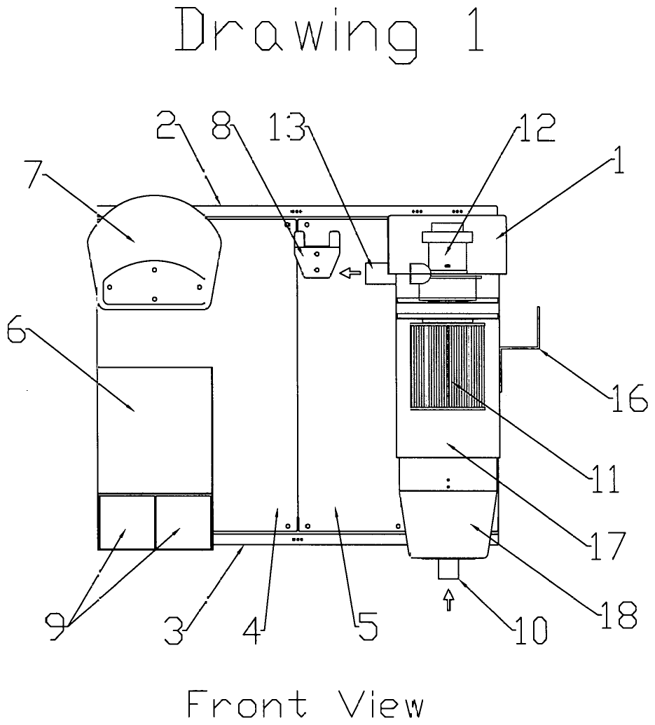

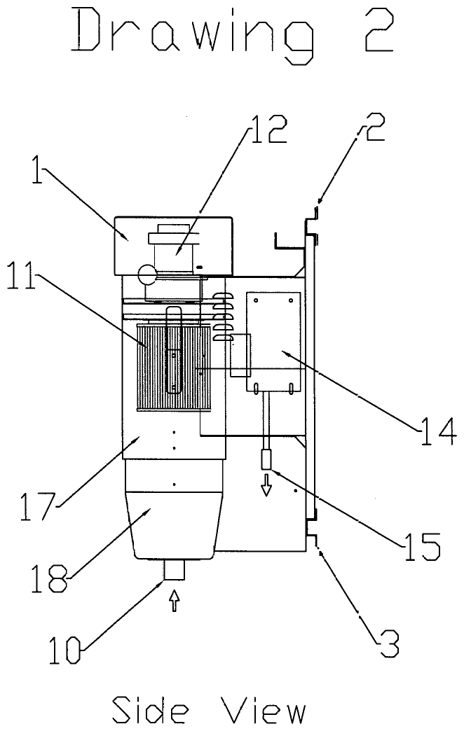

### BACKGROUND OF THE INVENTION

### Field of the Invention

This invention relates to vacuum systems; and, more particularly to a wall-mounted vacuum, combined with a blower, combined with a tankless air compressor that are integrated into a single unit and provides for a plurality of functions. Furthermore, the invention relates to a wall-mounting system, combined with a multi-compartment tool and accessory storage bin, combined with a vacuum floor wand hanger, combined with hose hangers for the vacuum/blower hose and the high-pressure air hose. Overall, the invention provides a plurality of functionalities, including dry vacuuming, a high-flow high-velocity air blower, and tankless air compressor functions, suitable for a wide variety of applications, and when mounted on the wall, provides a clean, organized look that keeps things off the floor and facilitates convenience of use. Because the air compressor in the system is of a tankless variety, it does not require any time to pressurize a holding tank, and thus is ready to use as soon as it is turned on, making its use quick and convenient.

### Description of Prior Art

Many patents address issues related to vacuum cleaning functionality and blower functionality and compressor functionality as separate devices. Additionally, several patents address issues related to wall-mounted vacuums. There are also patents that relate to machines that combine a vacuum and blower function in one, a vacuum and air compressor (tankless or otherwise) function in one, and even a vacuum and blower and air compressor in one. None of these patents appear to describe an apparatus that combines a vacuum function with a blower function with a tankless air compressor function, combined with an integrated wall-mounting system that provides for tool and accessory storage as well as hose storage to accommodate organization and convenience and ease of use.

U.S. Pat. No. 7,179,062 to Kyle C. Drevitson, et al. discloses an integrated, yet divisible portable wet/dry shop vacuum unit and air compressor, with an integral compressed air holding tank. The system is described as capable of operating as a dry vacuum, a wet vacuum, a blower, and an air compressor, all housed in a portable vacuum canister on wheels. While the system described is capable of vacuum, blower, and compressor functions, it does not describe any method tool, accessory, or hose storage, and the compressed air holding tank must be fully charged before it can be used. Further, the system described is not intended to be wall-mounted nor does it facilitate the maintaining of a clean and well-organized installation, and as such, is not optimized for convenience of use.

### SUMMARY OF THE INVENTION

The Garage Air-N-Vac Station is an integrated wall-mounted vacuum, blower, and tankless air compressor system with wall-mounting hardware, tool storage, floor wand hanger and hose hangers. The integrated system is provided with a vacuum section, a blower section, a tankless air compressor section, an apparatus for wall-mounting, a multi-compartment tool and accessory storage bin, a floor wand hanger, and hose hangers for both the combined vacuum/blower hose as well as the compressed air hose. The vacuum and blower sections of the machine are powered by a single vacuum/blower motor, with the vacuum section of the machine utilizing the intake side of the vacuum/blower motor, and the blower section utilizing the discharge side of the vacuum/blower motor. In the vacuum section, a high-efficiency filter in front of the intake of the vacuum/blower motor prevents dust and debris from entering the vacuum/blower motor, and thus, from being discharged from the blower section of the machine. In a separate section of the machine, an independently operated tankless compressor provides compressed air at full capacity. The machine is operated by a single control switch which has an “off” position, a “vacuum/blower” position, and a “air compressor” position. The vacuum and blower sections of the machine share a single hose, which is attached to either the intake port for the vacuum function, or to the discharge port for the blower function. Various tools and accessories can be attached to the vacuum/blower hose to accommodate a variety of applications. A dedicated air hose is attached to the tankless air compressor, and various tools and accessories can be attached for various applications. Primarily intended for installation in a garage, shop, or pole barn, the integrated wall-mounted vacuum, blower and tankless air compressor system with wall-mounting hardware, tool storage, floor wand hanger and hose hangers provide a high-performance vacuum for dry vacuuming, a high-flow high-velocity air blower for blowing, drying, and inflating, and on-demand, hi-pressure air flow for tire inflation, momentary air blasts, and pneumatic impulse tool operation. Furthermore, the integrated wall-mounted system provides for the organized storage of various tools and accessories for use with the different machine functions, as well as a hanger for a vacuum floor wand and both the vacuum/blower hose and the air hose. The combined system provides a range of functional capabilities with all the necessary hangers and storage needed to keep things organized, with everything mounted on the wall to save floor space, and ready to use at the flip of a switch. Because the air compressor in the system is of a tankless variety, it does not require any time to pressurize a holding tank, and thus is ready to use as soon as it is turned on, making its use quick and convenient.

### BRIEF DESCRIPTION OF THE DRAWINGS

There are two drawings that clearly represents the current design of the operating system—

Drawing 1 is a front view of the system and Drawing 2 is a side view of the system. The drawings identify the entire system, including the integrated vacuum, blower, and compressor system, as well as the integrated mounting hardware, tool storage bins, floor wand hanger, and hose hangers. The hoses and attachments are not shown in the drawings.

### DETAILED DESCRIPTION OF THE INVENTION

The present invention is an all-in-one machine that provides a vacuum, a high-flow high-velocity blower, and a high-pressure tankless air compressor that is integrated into a single unit, as well as having provisions for wall-mounting, tool and accessory storage, and the storage of all hoses. It is designed for premium performance, easy installation, cleanliness and organization, aesthetic appearance, and simplicity and convenience of use.

The vacuum section of the unit provides for a very powerful dry vacuum function and based upon the suction and air flow parameters of the integrated vacuum/blower motor, is more than capable of operating with a very long vacuum/blower hose attached (more than 50 feet). This capability accommodates a very large working area and allows the machine to be used to clean a large garage, shop, or pole barn. Further, because of its reach, the vacuum can be used to clean a variety of vehicles, including cars, boats, buses, and RV's.

The blower section of the unit provides a very powerful high-flow, high-velocity blower function, and again, based upon the pressure and air flow parameters of the integrated vacuum/blower motor, is more than capable of operating with a very long vacuum/blower hose attached (more than 50 feet). This capability accommodates a very large working area and allows the machine to be used to blow dust, dirt, and debris out of a large garage, shop, or pole barn. Further, because of its reach, the blower can be used to as a handheld dryer for a variety of vehicles, including motorcycles. Additionally, the blower can be used to inflate a variety of items, such as air mattresses, pool toys, and boat innertubes.

The tankless air compressor section of the unit provides an almost instantaneous supply of high-pressure air flow. The reach of the air compressor is only limited by the length of air hose attached. Because the air compressor used is of a tankless variety, it does not require any time to charge a holding tank before it can be used. The air compressor function of the machine is ideal for maintaining the proper pressure level in car, bike, truck, trailer, or RV tires and can also be used to inflate basketballs, footballs, etc . . . Beyond these basic inflation capabilities, the air compressor generates enough air flow and pressure to operate a blow-off gun and even a pneumatic impulse tool such as a nail gun. The air compressor function of the machine is not intended to replace a larger compressor with a holding tank, needed to operate many pneumatic tools, but it facilitates the ability to be used immediately, at the flip of a switch.

Beyond the concept of combining multiple functions into a single operating platform, the design of the overall system is unique and novel in that it has been optimized regarding the amount of wall space required for mounting, while at the same time, maintaining the highest level of convenience and aesthetic appearance. The mounting system has been designed to make installation simple and straight forward and provides adequate storage for a variety of tools and accessories that can be used across the various functions of the machine. Additionally, accommodations have been made for the hanging of a vacuum floor wand, as well as both a long vacuum/blower hose and a long air hose. When fully installed, ease of access to any tool, accessory, or hose makes the complete machine set-up easy and convenient to use and looking good.

Referring to Drawing 1 and Drawing 2, the complete system is comprised of the integrated vacuum, blower and compressor unit 1, the upper mounting rail 2, the lower mounting rail 3, the left-hand mounting panel 4, the right-hand mounting panel 5, the tool storage bin 6, the vacuum hose hanger 7, the floor wand hanger bracket 8, and the storage trays for small items 9. The operational machine 1 has two basic modes of operation: the vacuum/blower mode, and the air compressor mode. A 3-way switch (not shown) controls the function of the machine, with the middle position being “off”, the up position activating the “vacuum/blower” mode, and the down position activating the “air compressor” mode. When operating in the vacuum/blower mode, air is drawn into the machine through the vacuum intake 10, passes through the high-efficiency air filter 11, is drawn into the vacuum/blower motor 12, and is discharged through the blower pipe 13. To utilize the machine as a vacuum, the vacuum/blower hose (not shown) is attached to the vacuum intake 10, and the high-efficiency air filter 11 traps all the dirt, dust and debris in the vacuum chamber 17, and the dirt and debris is collected in the detachable dirt bucket 18; to utilize the machine as a blower, the vacuum hose (not shown) is attached to the blower pipe 13, and the high efficiency filter 11 ensures that the discharge air flow from the blower pipe 13 is clean and free of debris. When operating in the air compressor mode, the air compressor 14 produces compressed air, which exits through a discharge pipe 15, and incorporates an adjustable pressure relief valve (not shown), that allows the user to set the maximum pressure output of the compressor as needed. A high-pressure air hose (not shown) is attached to the discharge pipe 15, and a variety of attachments (not shown) can be connected to the opposite end of the air hose (not shown) for several applications. There is a dedicated vacuum hose hanger 7 for the vacuum hose, and a dedicated air hose hanger 16 for the high-pressure air hose. There is a dedicated floor wand hanger bracket 8 for hanging and storing the floor wand (not shown), and there is a tool storage bin 6 for storage of the other vacuum hose attachments (not shown). The tool storage bin 6 includes two storage trays for small items 9, including all the attachments for the high-pressure air hose (not shown). The operational machine 1, the tool storage bin 6, the vacuum hose hanger 7, and the floor wand hanger bracket 8 all attach to the mounting system, as shown in the Drawings. The mounting system consists of an upper rail 2 and a lower rail 3, intended to be securely mounted to the wall, and a left-hand mounting panel 4 and a right-hand mounting panel 5, designed to attach to the two mounting rails. The rails 2, 3 include pre-drilled holes for both 16″ and 24″ stud spacing in the wall, and the vertical panels 4, 5 incorporate pre-drilled holes and threaded inserts for mounting all the components of the complete system.

1) (canceled)

2) (canceled)

3) (canceled)

4) (canceled)

5) (canceled)

6) (canceled)

7) (canceled)

8) (canceled)

9) (canceled)

10) (canceled)

11) (canceled)

12) (canceled)

13) (canceled)

14) (canceled)

15) (canceled)

16) (canceled)

17) (canceled)

18) (canceled)

19) (canceled)

20) An integrated wall-mounted vacuum, blower and air compressor system comprising:
a) a vacuum section comprising:
i) a combination vacuum/blower motor, utilizing the intake port to create suction and high-volume airflow;
ii) a high-efficiency air filter to separate dirt and debris from the incoming air stream;
iii) a vacuum chamber with a detachable debris collection bucket;
iv) a vacuum intake tube to attach a vacuum/blower hose; and
v) a combination vacuum/blower hose appointed to receive a variety of vacuum tools and accessories;
b) a blower section comprising:
i) a combination vacuum/blower motor, utilizing the discharge port to create pressure and high-volume airflow;
ii) a blower discharge tube to attach a vacuum/blower hose; and
iii) a combination vacuum/blower hose appointed to receive a variety of blower tools and accessories;
c) a compressor section comprising:
i) a tankless air compressor to create high-pressure and moderate airflow;
ii) an adjustable air pressure relief valve;
iii) a means for attaching a high-pressure air hose; and
iv) a high-pressure air hose appointed to receive a variety of air tools and accessories;
d) a single three-way switch (On-Off-On) to activate either the combination vacuum/blower motor or the air compressor;
e) a tool storage compartment comprising:
i) a larger compartment to store a variety of larger tools and accessories; and
ii) a smaller compartment holding two removable storage bins to store a variety of smaller tools and accessories;
f) a wand hanger bracket to store a vacuum floor wand with an attached vacuum floor tool;
g) a hose hanger to store the combination vacuum/blower hose;
h) a hose hanger to store the high-pressure air hose;
i) a wall-mounting system comprising:
i) an upper and lower horizontal mounting rail to attach to the structure of a wall (the wall studs); and
ii) two vertical mounting panels to accommodate the attachment of all components of the overall vacuum, blower, and air compressor as well as the tool storage, wand hanger, and hose hangers;
whereby said integrated wall-mounted vacuum, blower and air compressor system provides functionalities of a dry vacuum, a blower, a dryer, an inflator, and an air compressor in a single unit.

21) An integrated wall-mounted vacuum, blower and air compressor system as recited in claim 20, wherein said vacuum, blower and air compressor are contained within a single operational unit, and said unit is controlled by a single electrical switch to activate either the vacuum/blower motor or the air compressor.

22) An integrated wall-mounted vacuum, blower and air compressor system as recited in claim 20, wherein said vacuum and blower functions utilize the same hose, and said hose is attached to either the vacuum intake tube to operate as a vacuum, or the blower discharge tube to operate as a blower.

23) An integrated wall-mounted vacuum, blower and air compressor system as recited in claim 20, wherein said combined vacuum/blower motor can generate enough airflow and suction (pressure) as to accommodate a very long vacuum/blower hose (50 feet or more) and still provide a high level of performance in either mode of operation, over a large working area.

24) An integrated wall-mounted vacuum, blower and air compressor system as recited in claim 20, wherein a very long high-pressure air hose (50 feet or more) is attached as to provide a moderate volume of air stored at pressure and allow for a large working area.

25) An integrated wall-mounted vacuum, blower and air compressor system as recited in claim 20, wherein because of the nature of said tankless air compressor (not requiring any time become fully charged to pressure) the system can be used in any functional mode, almost immediately, at the flip of a switch, making it highly convenient and easy to use.

26) An integrated wall-mounted vacuum, blower and air compressor system as recited in claim 20, wherein said wall-mounting system, tool storage bins, wand and hose hangers accommodate the preservation of floor space within any building and facilitate keeping the area clutter free and organized at all times.
